(19) United States
(12) Patent Application Publication
(10) Pub. No.: US 2022/0255889 A1
(43) Pub. Date: Aug. 11, 2022

(54) TRENDING THREAD IDENTIFIERS FOR GROUP CONVERSATIONS

(71) Applicant: Avaya Management L.P., Durham, NC (US)

(72) Inventors: Pushkar Yashavant Deole, Pune (IN); Sandesh Chopdekar, Pune (IN); Navin Daga, Silapathar (IN)

(21) Appl. No.: 17/171,363

(22) Filed: Feb. 9, 2021

(51) Int. Cl. H04L 12/58; G06N 20/00

(52) U.S. Cl. CPC H04L 51/14; G06N 20/00; H04L 51/046; H04L 51/26; H04L 51/32; H04L 51/16

(57) ABSTRACT

The technology disclosed herein enables presentation of trending thread identifiers in group conversations. In a particular embodiment, a method provides determining posting characteristics for posts in a conversation thread between users in a group of users. The posting characteristics include a current topic for the conversation thread. Based on the posting characteristics, the method provides determining an importance of the conversation thread to the group. In response to the importance satisfying trending criteria, the method provides presenting an indication that the trending criteria is satisfied in association with an identifier of the conversation thread. The identifier is presented with identifiers for one or more other conversation threads associated with the group.

### TECHNICAL BACKGROUND

Group chats and conversations are increasingly popular, not only in social networks where they are already prominent form of communication, but also in enterprise communications where a group of people communicate through various private or public groups, also known as channels. As the number of topics (or threads of discussion) and/or the number of people continue to increase for conversations in a group, the topics/threads may become more unordered. The lack of order may make it difficult for a group member to determine an appropriate time or place (e.g., thread) in which to submit a message. For example, one or more topics may be trending over the group wherein a certain percentage of group members are participating in one or more of the topic discussions and are continuously contributing messages to the topic or thread of discussion with higher message rate than usual. For instance, in enterprise group chats a currently trending topic might be about a customer issue that has been escalated due to the customer being unhappy and, consequently, many members of group are contributing messages to that topic since it is a priority for almost the entire group. If a member of the group was to post a message off-topic to the current trending topic (i.e., unrelated to the customer issue), that message may be overlooked by the other members, who are currently concerned with the customer issue. Especially in situations where there are a large number of group members/topics in the group conversation(s), the fact that the other members are presently concerned with the customer issue may be unbeknownst to the member posting the message. Similarly, in a non-enterprise example, a conversation thread of a group on a social networking platform may be presently concerned with a specific topic, such as a death in one member's family. If a member were to post on an alternative topic, that member's post is likely to be overlooked (e.g., drowned out by posts expressing condolences to the member that suffered the loss).

### SUMMARY

The technology disclosed herein enables presentation of trending thread identifiers in group conversations. In a particular embodiment, a method provides determining posting characteristics for posts in a conversation thread between users in a group of users. The posting characteristics include a current topic for the conversation thread. Based on the posting characteristics, the method provides determining an importance of the conversation thread to the group. In response to the importance satisfying trending criteria, the method provides presenting an indication that the trending criteria is satisfied in association with an identifier of the conversation thread. The identifier is presented with identifiers for one or more other conversation threads associated with the group.

In some embodiments, the method provides presenting a time-based indication of the importance changing over time in association with the identifier. In those examples, the time-based indication may include a timeline representing an amount of time up until a current time.

In some embodiments, the indication includes a user selectable identifier of a previous time when the trending criteria was satisfied and, upon receiving a selection of the user selectable identifier, the method includes opening the conversation thread to one or more of the posts that were posted during the previous time.

In some embodiments, the method includes determining post characteristics of a post for submission to a second conversation thread between the users and determining a probability that the post will be overlooked by other users in the group based on the post characteristics. In response to a user instruction to submit a post to the second conversation thread and the probability satisfying overlook criteria, the method includes presenting a visual alert informing the user that the post is likely to be overlooked. The visual alert provides the user with a first option to presently proceed with submitting the post to the conversation thread and a second option to not proceed with submitting the post. In those examples, the visual alert may provide the user with a third option to delay submission of the post and the method may include, after selection of the third option determining second posting characteristics for the posts and, based on the second posting characteristics, determining a second probability that the post will be overlooked by the other users in the group. In response to determining that the second probability satisfies submission criteria, the method provides submitting the post to the conversation thread. After submitting the post, the method may include notifying the user that the post has been submitted. Also, in the above examples, the post characteristics may include a post topic and determining the probability may include, in response to determining that the post topic is not related to the current topic, setting the probability to a higher value than if the post topic had been related to the current topic.

In some embodiments, the posting characteristics include one or more characteristics in a set comprising one or more topics other than the current topic, a volume of the posts, a flow rate of the posts, a post time of a most recent one of the posts, a user sentiment within the posts, and one or more identities of the users. In those examples, determining the importance may include, in response to determining that the user sentiment indicates urgency with respect to the current topic, adjusting the importance to indicate that the conversation thread is more important than had the urgency not been determined.

In some embodiments, the method includes training a machine learning algorithm using predefined indications of importance for previous posts, having previous posting characteristics, in a plurality of previous conversation threads. The machine learning algorithm learns patterns in the previous posting characteristics associated with the redefined indications of importance. In those embodiments, determining the importance may include inputting the posting characteristics into the machine learning algorithm, wherein the machine learning algorithm outputs the importance.

In another embodiment, an apparatus is provided having one or more computer readable storage media and a processing system operatively coupled with the one or more computer readable storage media. Program instructions stored on the one or more computer readable storage media, when read and executed by the processing system, direct the processing system to determine posting characteristics for posts in a conversation thread between users in a group of users. The posting characteristics include a current topic for the conversation thread. The program instructions further direct the processing system to determine an importance of the conversation thread to the group based on the posting characteristics. In response to the importance satisfying trending criteria, the program instructions direct the processing system to present an indication that the trending criteria is satisfied in association with an identifier of the conversation thread. The identifier is presented with identifiers for one or more other conversation threads associated with the group.

### BRIEF DESCRIPTION OF THE DRAWINGS

FIG. 1 illustrates an implementation for presenting identifiers for trending group conversation threads.

FIG. 2 illustrates an operation to present identifiers for trending group conversation threads.

FIG. 3 illustrates an operational scenario for presenting identifiers for trending group conversation threads.

FIG. 4 illustrates another operational scenario for presenting identifiers for trending group conversation threads.

FIG. 5 illustrates yet another operational scenario for presenting identifiers for trending group conversation threads.

FIG. 6 illustrates an implementation for presenting identifiers for trending group conversation threads.

FIG. 7 illustrates another implementation for presenting identifiers for trending group conversation threads.

FIG. 8 illustrates yet another implementation for presenting identifiers for trending group conversation threads

FIG. 9 illustrates a computing architecture for presenting identifiers for trending group conversation threads.

### DETAILED DESCRIPTION

The examples provided herein determine whether posts in a conversation thread for a group of users (i.e., members of the group) satisfy criteria for indicating that the conversation thread is trending relative to the importance of the thread's topic to the group. If the criteria is satisfied an indication is presented in association with an identifier for the conversation thread. If a user in the group is presented with the indication may then adjust their interactions with the conversation thread, or other conversation threads, accordingly. For example, the user may be browsing conversation threads to determine whether their input would be beneficial. If one thread is indicated to be trending within the members of user's group, then the user may be more apt to look into that thread determine whether their input would be beneficial to the thread's topic. In another example, the user may be wanting to submit a post about a particular topic to a group conversation thread (e.g., to a newly created thread, possibly by the user themselves for this particular post, or to an already existing thread). If another topic thread is currently indicated as trending within the members of the group, then the user may decide to hold off on submitting their post until a later time when the group members are not otherwise occupied with the trending topic. The user may also look at the trending indicators for all threads that are active and then decide to first look at the posts of most trending thread instead of going through the threads in the order in which they are created/appearing in the user interface. Of course, a user presented with the trending indicator may react in other ways to the knowledge provided thereby.

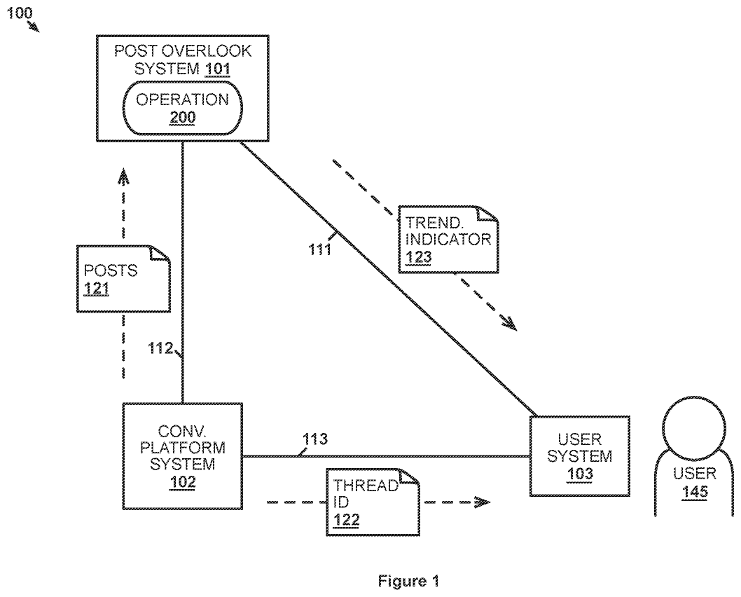

FIG. 1 illustrates implementation 100 for presenting identifiers for trending group conversation threads. Implementation 100 includes post overlook system 101, conversation platform system 102, and user system 103. Post overlook system 101 and conversation platform system 102 communicate over communication link 112. Post overlook system 101 and user system 103 communicate over communication link 111. Conversation platform system 102 and user system 103 communicate over communication link 113. Communication links 111-113 are shown as direct links but may include intervening systems, networks, and/or devices.

In operation, conversation platform system 102 is a computing system (e.g., data server), or collection of computing systems, that hosts a communication platform that enables one or more groups of users to participate in conversations within their respective groups via their respective user systems. The communication platform may be available to the public (e.g., may be a public social network) and/or may be a private communication platform available to select individuals (e.g., employees of an enterprise). In some cases, the communication platform may host groups communications for both private and public groups. For example, a group of users may form a private group within a public social network. In some cases, conversation platform system 102 may be a remote (e.g., in a cloud server location) system while, in other cases, conversation platform system 102 may be an on-premises system (e.g., physically located in a building belonging to an enterprise using conversation platform system 102).

User 145 is a member of a group of users for which conversation platform system 102 hosts one or more conversations. Members of the group may be defined by user 145, by another user in the group, by another user not in the group (e.g., a system administrator of the members' employer), or by some other entity. Distinct conversations are commonly referred to as conversation threads and that is how they are referred to herein, although, other terms may be used instead to indicate distinct conversations between two or more users on a communication platform. User 145 operates user system 103 to read and/or post content (e.g., text/voice/video messages, documents, media files, etc.) in conversation threads for the group in which user 145 is a member. For example, one member of the group may post a message asking a question to a conversation thread hosted by conversation platform system 102 and user 145 may respond to that message by posting a message with the answer to that question. In some examples, conversation platform system 102 may host a single conversation thread per group of users, rather than allowing a group to create multiple threads associated with the group. User system 103 may be a laptop computer, desktop computer, smartphone, tablet computer, or some other user operable computing device. User system 103 may execute a client application (e.g., either stand-alone or through a web browser) that provides a graphical user interface for user 145 to access the conversation threads and instructs user system 103 on how to interact with conversation platform system 102.

Post overlook system 101 also has access to the conversation threads of the group in which user 145 is a member. User 145 may explicitly provide post overlook system 101 with the permission(s) necessary for post overlook system 101 to access the conversation threads (e.g., may provide post overlook system 101 with their login credentials) or post overlook system 101 may receive access in some other manner (e.g., by an administrator configuring post overlook system 101 accordingly). With access to the conversation threads, post overlook system 101 performs operation 200 to provide user 145 with indications about whether a particular communication thread is trending (e.g., important, popular, active, etc.) within user 145's group. While shown separately in implementation 100, post overlook system 101 may be incorporated into conversation platform system 102 or user system 103. If incorporated into conversation platform system 102, post overlook system 103 may not require access credentials as post overlook system 103 may be a feature of the platform itself.

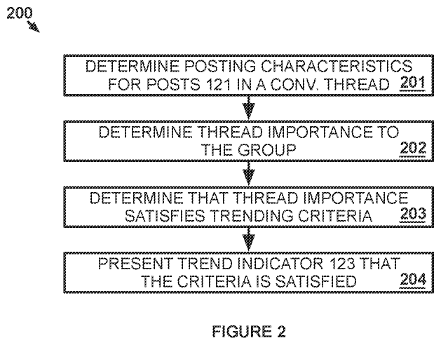

FIG. 2 illustrates operation 200 to present identifiers for trending group conversation threads. In operation 200, post overlook system 101 determines posting characteristics for posts 121 in a conversation thread between users in a group of users, which includes user 145 in this example (201). When post overlook system 101 is a separate system, as is the case in implementation 100, post overlook system 101 receives posts 121 from conversation platform system 102. Posts 121 may be all of the posts in the conversation thread or may be a subset of all the posts, such as a predefined number of the most recent posts or all the posts submitted within a predefined amount of time prior to the current time. Posts 121 may all include content of the same type (e.g., text) or may contain varying types of content (e.g., some posts may be text only while other posts may include pictures). Posts 121 may be obtained by post overlook system 101 all at once, periodically, as each of posts 121 is submitted to conversation platform system 102, or on some other schedule. The posting characteristics for posts 121 may include a topic (or topics) of a post, a current topic of the conversation thread (e.g., as indicated by the topic of the most recent posts of posts 121), a volume of posts in posts 121, a flow rate of the posts in posts 121 (including how the rate changes over time), a post time for the most recent post of posts 121, information about posting users' identities (e.g., a posting user's name, job title, seniority level, age, etc.), user sentiment within the posts (e.g., anger, happiness, anxiety, urgency, etc.), or some other type of information descriptive of posts 121 or the users that submitted posts 121.

In some examples, one or more artificial intelligence (AI) and/or machine learning algorithms may be used by post overlook system 101 to determine a conversation thread topic. The algorithms may be trained to identify topics from explicit topic statements in posts 121 or from context. For instance, a user may never explicitly post, in posts 121, the current topic of discussion (e.g., may never post “I want to talk about X particular issue in Y product”). Instead, the users in the discussion may simply start posting after grasping the topic from context. The algorithms may be trained to similarly grasp the topic from context. One of the algorithms may be trained using posts from previous conversations having known topics that are also indicated to the algorithm in association with their respective posts. The algorithm may also be trained to use external information, such as documentation (e.g., files, websites, media, etc.) relevant to the group, to determine the topic. For example, the documentation may include information about product lines, features, part numbers, etc. for an enterprise having the group. If the algorithm finds a particular feature being discussed, then the algorithm may use the documentation to determine a product having that feature to include more detail for a determined topic. The same, or similar, algorithms may also be used to determine other characteristics (e.g., user sentiment) that may not be explicitly defined within posts 121. For example, an algorithm may be trained using posts from previous conversations having known user sentiments that are also indicated to the algorithm in association with their respective posts. From that training, the algorithm can identify the user sentiment in posts 121 based posts 121 being similar (e.g., using similar words to previous posts having the same user sentiment).

Based on the posting characteristics, post overlook system 101 determines an importance of the conversation thread to the group (202). The importance is relative to the particular group because the importance to the group may be different from if the conversation thread was in a different group (i.e., the importance is tailored to the users in the group). The importance may be a value (e.g., a score) within a range of values (e.g., a number between 0 and 10 where 10 represents the highest importance), may be an importance level indication (e.g., low, medium, or high importance), or may be some other indication of importance. Post overlook system 101 may start with an initial importance indication for a thread (e.g., medium or 5 from the examples above) and then adjust that initial importance to be more or less important depending on the posting characteristics for posts 121. For example, post overlook system 101 may start with a low importance indication (e.g., a 2 on the above scale of 0-10) and then increase the importance based on user sentiment in posts 121 indicating that a topic in posts 121 is urgent. Alternatively, each posting characteristic may have an associated point value that are all added together to generate a resulting score. Other manners of representing importance from posting characteristics may also be used.

Post overlook system 101 may be configured to weigh posting characteristics differently determining the importance, which causes post overlook system 101 to adjust the importance different amounts from different posting characteristics. For instance, who is posting (e.g., low level tech, engineer, vice president, etc.) may affect importance more than the user sentiment or vice versa. In another example, what post overlook system 101 determines to be an important topic may be counteracted by low post activity in posts 121, which causes post overlook system 101 to determine that the conversation thread is actually of lower importance due to not many users currently discussing the topic in posts 121). In some cases, certain combinations of posting characteristics may be weighed differently than if post overlook system 101 considered those characteristics separately (e.g., when a vice president is posting with user sentiment).

Post overlook system 101 further determines whether the importance satisfies trending criteria (203). The trending criteria is one or more criterion that indicates to post overlook system 101 that the conversation thread of posts 121 is trending and user 145 (or other users in the group) should be notified of that fact. If the importance is represented on a numeric scale (e.g., the 0-10 scale mentioned above), then the trending criteria may be a threshold number on that scale. For example, with 10 being the most important, the trending criteria threshold may require that the importance be a 9 or higher to be satisfied. Alternatively, in the low, medium, or high importance example, the trending criteria may simply indicate that the determined importance needs to be “high” to be satisfied. Of course, other manners of defining trending criteria may be used in other examples depending on how importance is represented.

In response to the importance satisfying the trending criteria, post overlook system 101 presents trend indicator 123, which is an indication that the trending criteria is satisfied, in association with thread identifier 122, which identifies the conversation thread (204). In this example, post overlook system 101 presents trend indicator 123 by transferring trend indicator 123 in a message to user system 103 so that user system 103 can display a graphical representation of trend indicator 123 to user 145. Instructions directing user system 103 to present trend indicator 123 may be transferred to user system 103 as well or user system 103 may be preconfigured to present trend indicators, such as trend indicator 123, upon receipt from post overlook system 101. Software instructions that direct user system 103 to display trend indicator 123 may be incorporated into a client application that allows user system 103 to access conversation platform system 102. In another example, the instructions may be separate software, such as a browser plugin, that overlays a graphical representation of trend indicator 123 onto a display of conversation thread identifiers from conversation platform system 102.

The identifier for the conversation thread of posts 121 is also presented at user system 103 with identifiers for one or more other conversation threads associated with the group. As such, when trend indicator 123 is displayed to user 145 in visual association with thread identifier 122, user 145 can easily recognize that the conversation thread with posts 121 is trending relative to the other conversation threads to which user 145 has access as a member of the group. In some examples, post overlook system 101 may perform the steps described above with respect to the other conversation threads and present a trend indicator in visual association with any of those other threads that are also trending. The other conversation threads may be explicitly distinct conversation threads in conversation platform system 102 or user system 103 (or another system) may artificially separate posts of a single conversation thread on conversation platform system 102 into different threads based on the conversation topic therein.

Trend indicator 123 may be displayed next to thread identifier 122 (e.g., a label or title) for the conversation thread, may be displayed in a visual area designated for the conversation thread, may include a pointer element directed at the conversation thread, or may be displayed in some other manner that associates trend indicator 123 with the conversation thread of posts 121 rather than another thread. In some examples, nothing regarding whether the conversation thread is trending may be displayed prior to the display of trend indicator 123. In other examples, a different indicator may previously be displayed to indicate the activity level of a thread (or how the activity level changes over time) even though the thread was not trending at that previous time. Trend indicator 123 would then replace, or be a different variation of, the previous indicator to show that the conversation thread is now trending (e.g., display in a different color).

Advantageously, when presented with trend indicator 123, user 145 can use the information provided by trend indicator 123 (i.e., information indicating that the topic of trend indicator 123 is trending) to determine how to interact with the conversation threads. For example, user 145 may determine that they should review posts 121 to provide input to the conversation, if necessary. Alternatively, user 145 may determine that a post that they want to create is not relevant to the trending conversation thread and may, therefore, decide to hold off on posting to decrease the likelihood that the group will overlook user 145's post while the group's focus is on the trending conversation thread.

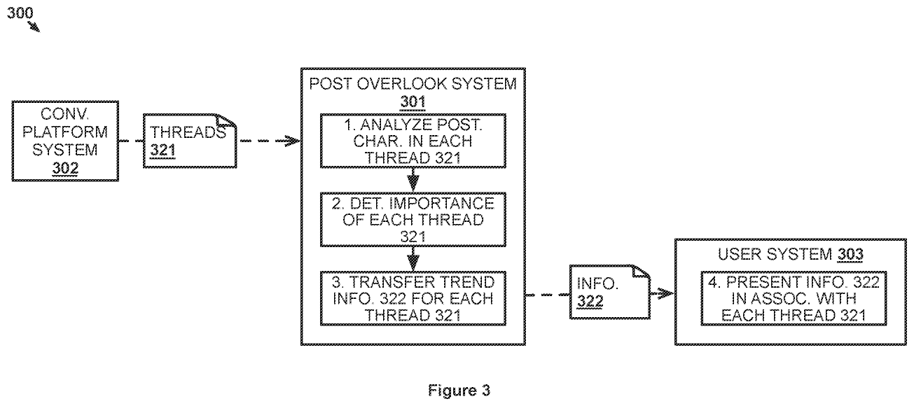

FIG. 3 illustrates operational scenario 300 for presenting identifiers for trending group conversation threads. Operational scenario 300 includes post overlook system 301, conversation platform system 302, and user system 303. Post overlook system 301 is an example of post overlook system 101. Conversation platform system 302 is an example of conversation platform system 102. User system 303 is an example of user system 103. Operational scenario 300 is an example of how post overlook system 301 handles multiple conversation threads associated with a group of users.

In operational scenario 300, post overlook system 301 analyzes posting characteristics at step 1 in each of conversation threads 321 received from conversation platform system 302. Conversation threads 321 comprise two or more conversation threads hosted by conversation platform system 302 for users in a group of users. Each of conversation threads 321 includes one or more posts from users in the group. Post overlook system 301's analysis of the posting characteristics involves post overlook system 301 determining the posting characteristics for the posts in each of conversation threads 321. Posts of conversation threads 321 may be received all at once or may be received over time (e.g., on a periodic basis) so that post overlook system 301 does not have to receive and analyze all of conversation threads 321 at once. For example, post overlook system 301 may request updates (i.e., new posts) to conversation threads 321 periodically or conversation platform system 302 may push new posts to post overlook system 301 for analysis as they are received rather than all at once.

From the posting characteristics, post overlook system 301 determines an importance of each of conversation threads 321 at step 2. The importance includes at least a current importance to the group of users for each of conversation threads 321. In this example, the importance over time may also be determined so that users can be informed about how the importance has fluctuated, or trended, over time (e.g., show that a thread was important within the group two hours ago but is not currently important). To determine importance over time, post overlook system 301 may analyze all posts in each of conversation threads 321 since creation of each of conversation threads 321 or may select a subset of those posts (e.g., a predefined number of previous posts or all the posts within a predefined amount of time). For example, user system 303 may present indicators of importance over the past three hours for each of conversation threads 321 and post overlook system 301 would, therefore, analyze the past three hours' worth of posts in each of conversation threads 321 regardless of the number of posts.

After determining the importance of each of conversation threads 321, post overlook system 301 generates and transfers trend information 322 at step 3 to user system 303. Trend information 322 is information indicating which, if any, of conversation threads 321 are currently trending within the group (i.e., currently important to the group based on trending criteria applied by post overlook system 301). In this case, trend information 322 also includes information about how conversation threads 321 trended over time (i.e., how their importance changed over time). Upon receiving trend information 322, user system 303 presents, at step 4, the portions of trend information 322 corresponding to respective conversation threads 321 in visual association with identifiers for the respective conversation threads 321. The identifiers for conversation threads 321 may include a listing of conversation threads 321 with a label of some type identifying each conversation threads 321. For example, a title or topic for a thread may identify the thread, a first post may identify the thread (e.g., if the first post asks a question, then that question may identify the thread), or some other way in which a thread may be distinguished from other conversation threads 321. In some examples, each identifier may be displayed in a visual partition (e.g., a displayed box) dedicated to the corresponding thread. Within the visual partition, the portion of trend information 322 for the thread may be displayed along with other information about the thread, such as a preview of one or more posts within the thread, information about when a most recent post was submitted to the thread, an identity of the user who created the thread, or some other type of thread-related information.

At least those of conversation threads 321 determined to satisfy the trending criteria have an indicator displayed in association therewith to indicate to a user that the conversation thread is trending. The trending indicator may be a graphic, such as an icon, may be words explaining that the thread is trending (e.g., “This thread is important to your group”), may be incorporated into an indicator for the importance over time of the thread (e.g., the indicator for importance over time may change color, size, shape, etc.), or may be some other visual indication that a user would identify as indicating a trending thread. Similarly, displaying the importance over time may include an explicit description of when the thread was trending (e.g., “This thread was important one hour ago”) or may be a graphic, such as a timeline that changes color, pattern, amplitude, etc. along the timeline to represent when the associated thread was trending at any given time. For example, if the timeline spans three hours and the thread was trending two hours ago, then one-third of the way along the timeline may change colors to represent that the thread was trending two hours ago and remain that color along the timeline for the duration in which the thread was trending. Upon viewing trend information 322 presented by user system 303, a user can easily recognize whether a thread is currently trending and whether (and when) a thread was trending in the past.

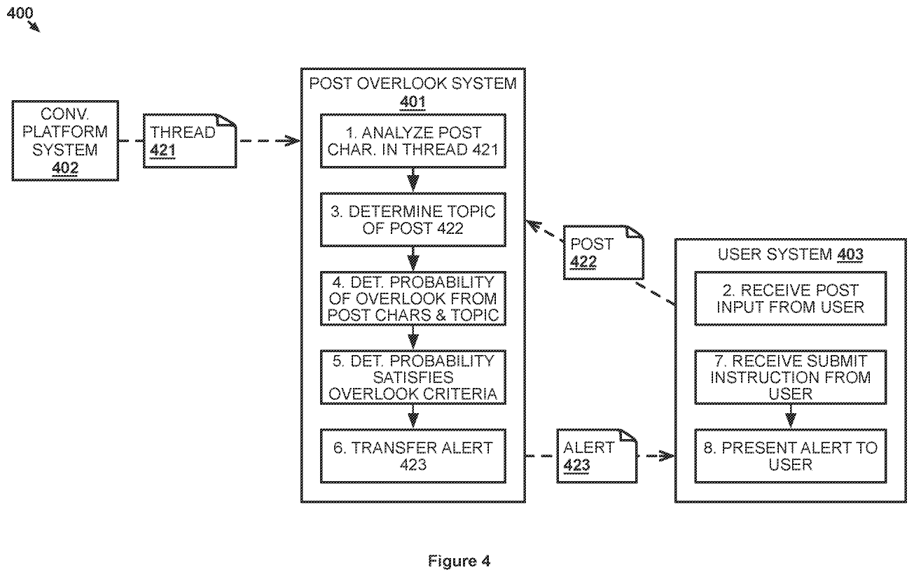

FIG. 4 illustrates operational scenario 400 for presenting identifiers for trending group conversation threads. Operational scenario 400 includes post overlook system 401, conversation platform system 402, and user system 403. Post overlook system 401 is an example of post overlook system 101, conversation platform system 402 is an example of conversation platform system 102, and user system 403 is an example of user system 103. Operational scenario 400 is an example of how post overlook system 401 may provide an alert to a user should the user attempt to submit a post that is likely to be overlooked.

In operational scenario 400, post overlook system 401 receives conversation thread 421 and analyzes the posting characteristics of posts therein at step 1. Like in the examples above, post overlook system 401 at least determines a current topic characteristic for the posting characteristics but other posting characteristics discussed herein may also be useful. Conversation thread 421 may be analyzed along with other conversation threads in a manner similar to the analysis of conversation threads 321 performed in operational scenario 300. Thus, if post overlook system 401 also presents trend information like post overlook system 301, then conversation thread 421 would not have to be analyzed separately from the other conversation threads. In some examples, post overlook system 401 may analyze conversation thread 421 in response to receiving post 422, which is discussed in more detail below. For example, even if post overlook system 401 already analyzed conversation thread 421 when determining trend information for presentation to the user, when the user is ready to submit post 422, additional posts may have been submitted and post overlook system 401 analyzes those additional posts.

A user of user system 403 provides input into user system 403, at step 2, that creates a post for submission to conversation thread 421. For example, the user may type text into a text entry field, may select one or more photos, may select one or more documents, and/or any other type of content that conversation platform system 402 allows a user to post. Post 422 is transferred to post overlook system 401 and post overlook system 401 analyzes post 422 to determine a topic of post 422. Analysis of post 422 may include language processing of the text in post 422 or a document included therein, image recognition in an image of post 422, or some other form of content analysis. The topic of post 422 may be determined solely from information in post 422 or may be determined from information external to post 422. For example, posts already posted in conversation thread 421 may be used for context when language in post 422 alone is not enough to determine the topic of post 422. Other post characteristics may also be determined, such as post time, post length, identity of the user creating post 422, post type or any other characteristic descriptive of a post.

Based on the posting characteristics of conversation thread 421 (e.g., thread topic) and the topic of post 422, post overlook system 401 determines a probability that post 422 will be overlooked at step 4. The probability may be based solely on the posting characteristics analyzed from conversation thread 421 or post overlook system 401 may also consider posting characteristics from other conversation threads for the group, assuming there are any. The probability may be represented as a ratio, a percentage (e.g., 85% chance of overlook), a score, a level indication (e.g., low, medium, or high), or some other metric that may be defined to represent probability. Similar to when determining thread importance in the above examples, post overlook system 401 may start with an initial overlook probability (e.g., medium or 55% from the examples above) and then adjust that initial probability to be more or less probable depending on the posting characteristics of thread 421, the characteristics of post 422, and/or posting characteristics from other conversation threads of the group. For example, post overlook system 401 may start with a low probability indication (e.g., 10%) and then increase the probability percentage based on post 422 being off topic to conversation thread 421, based on other post characteristics of post 422, and/or based on the trending status of other communication threads for the group. Alternatively, each posting characteristic may have an associated point value that are all added together to generate a resulting probability score. Other manners of representing a probability that post overlook system 401 has determined for post 422 being overlooked may also be used.

In one example, post overlook system 401 may determine that the topic of post 422 does not relate to a topic (e.g., match the topic, stem from the topic, etc.) being discussed in conversation thread 421 and that the flow rate of new posts being submitted to conversation thread 421 indicates that post 422 will quickly be pushed out of a viewing window for new posts by those other posts. Post overlook system 401, therefore, may determine that other members of the group will overlook post 422 in favor of other incoming on-topic posts that replace post 422 as the newest posts to conversation thread 421. In another example, post overlook system 401 may determine that another conversation thread for the group is trending (i.e., is important to the group and members of the group are actively participating in that thread). If the group members are focused on that other thread, the likelihood that post 422 will be overlooked in conversation thread 421 is high even if the topic of post 422 is relevant to conversation thread 421.

In some examples, the overlook probability may be defined for a period of time. For instance, post overlook system 401 may calculate the probability of overlook during the next 30 minutes rather than for all time. As such, if a user was presented with the determined overlook probability, the user would be aware that the probability only applies to the next 30 minutes. If the user is ok with receiving a response after 30 minutes, the user may continue with the submission of post 422.

After determining the overlook probability, post overlook system 401 determines whether the overlook probability satisfies overlook criteria at step 5. The overlook criteria includes at least one criterion that, upon satisfaction, triggers post overlook system 401 to present an alert to a user of user system 403 indicating that post 422 has a high probability of being overlooked. If the probability is represented on a numeric scale (e.g., the percentage mentioned above), then the trending criteria may be a threshold number on that scale. For example, the overlook criteria threshold may require that the 70% or higher to be satisfied. Alternatively, in the low, medium, or high probability example, the criteria may simply indicate that the determined probability needs to be “high” to be satisfied. Of course, other manners of defining criteria may be used in other examples depending on how the probability is represented.

Upon determining that the overlook criteria is satisfied, post overlook system 401 transfers overlook alert 423, at step 6, in a message to user system 403. In this example, user system 403 stores overlook alert 423 until the user of user system 403 decides to submit post 422. If the user never instructs user system 403 to submit post 422, then overlook alert 423 may be discarded by user system 403. Although, in this example, user system 403 receives an instruction from the user to submit post 422 at step 7. Upon receiving the instruction, user system 403 presents overlook alert 423 to the user at step 8. User system 403 informs the user that post overlook system 401 has determined that post 422 is likely to be overlooked by other members of the group. Overlook alert 423 may be a visual alert, an audible alert, a tactile alert (e.g., a vibration), or some other type of alert. For example, user system 403 may display a popup window displaying overlook alert 423 and a play back a tone corresponding to overlook alert 423. Overlook alert 423 may provide details about the reason overlook alert 423 is being presented, such as the determined overlook probability and/or reasons for the determined overlook probability (e.g., conversation thread 421 being a non-trending thread).

In some examples, user system 403 may automatically proceed with submitting post 422 to conversation platform system 402 for inclusion in conversation thread 421 even though overlook alert 423 is presented. In other examples, overlook alert 423 may provide the user with options on how to proceed. For instance, overlook alert 423 may include a query to the user about whether user system 403 should proceed with submitting post 422 despite the overlook probability.

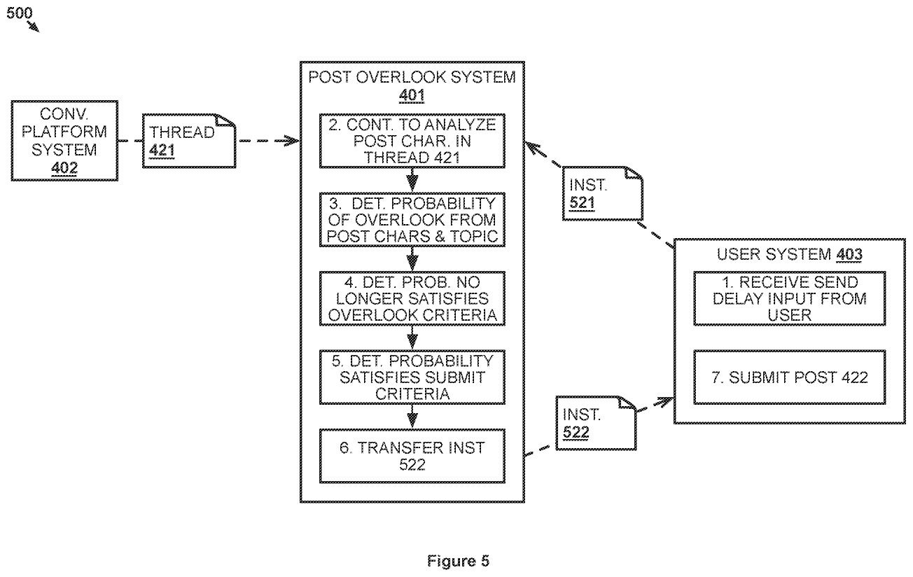

FIG. 5 illustrates operational scenario 500 for presenting identifiers for trending group conversation threads. Operational scenario 500 is an example extension upon operational scenario 400 and, therefore, includes post overlook system 401, conversation platform system 402, and user system 403. In operational scenario 500, overlook alert 423 included an option that, when selected by the user, delays submission of post 422 until the overlook probability reduces to a predefined level. Post 422 is then automatically submitted by user system 403.

Specifically, user system 403 receives user input from the user, at step 1, indicating that the user wishes to delay submission of post 422. If overlook alert 423 displayed a selectable graphical element, such as a button, then the user may provide the input by selecting the element, although other manners of providing input into user system 403 may also be used. The user input causes user system 403 to transfer delay instruction 521 to post overlook system 401 that instructs post overlook system 401 to determine when post 422 should be submitted. As such, upon receiving delay instruction 521 post overlook system 401 continues to analyze posting characteristics from new posts in conversation thread 421, at step 2, in a similar manner to that described in operational scenario 400. Post overlook system 401 may also continue to analyze posting characteristics from other conversation threads for the group.

As post overlook system 401 continues to analyze conversation thread 421 (and, potentially, other threads), post overlook system 401 also continues to update the overlook probability, at step 3, based on the current analysis. When the updated probability no longer satisfies the overlook criteria from operational scenario 400, as determined at step 4, post overlook system 401 moves on to determine whether submission criteria is also satisfied at step 5. In some examples, the overlook criteria not being satisfied alone may trigger post overlook system 401 to instruct user system 403 to submit post 422. However, in this example post overlook system 401 also employs submission criteria that must also be satisfied. The submission criteria is at least one criterion that must be satisfied to trigger transfer of submit instruction 522. For example, even if the overlook criteria is no longer satisfied, the submission criteria may require that it be a certain time of day (e.g., a time during regular business hours) so that post 422 does not get posted when members of the group are likely not working.

After determining that the overlook criteria is no longer satisfied and the submission criteria is satisfied, post overlook system 401 transfers submit instruction 522 to user system 403 at step 6. User system 403 automatically submits post 422 in response to receiving submit instruction 522 at step 7. The user of user system 403 did not have to remember to submit post 422 on their own accord at a later time since post overlook system 401 determined a time in which post 422 should be submitted automatically. In some examples, user system 403 may notify the user when post 422 is submitted.

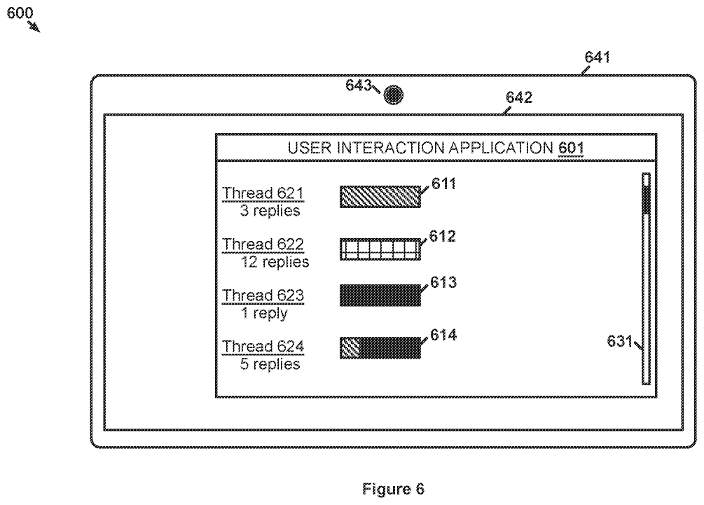

FIG. 6 illustrates implementation 600 for presenting identifiers for trending group conversation threads. Implementation 600 includes display system 641, which includes display screen 642 and camera 643. Display screen 642 may be a liquid crystal display (LCD), organic light emitting diode (OLED) display, cathode ray tube (CRT), or some other type of display in communication with processing circuitry of a user system, such as user system 103. Camera 643 includes optics, such as a lens, and an image sensor, also in communication with processing circuitry of a user system, that captured photos and/or video, which may be included in posts to conversation threads. Camera 643 may be omitted in some examples.

In this example, display screen 642 is displaying a window for user interaction application 601. User interaction application 601 is an example application that provides a user with access to interact with conversation threads hosted by a conversation platform system, such as conversation platform system 102. In this case, user interaction application 601 is displaying conversation thread 621, conversation thread 622, conversation thread 623, and conversation thread 624, which are conversation threads for a group in which a user of display system 641 is a member. The user may use scroll bar 631 to scroll through additional conversation threads that are not able to be viewed in user interaction application 601 at the same time as threads 621-624 due to lack of space.

As shown in implementation 600, user interaction application 601 displays an identifier for each of conversation threads 621-624 and provides information about how many replies each of conversation threads 621-624 has. More or less information may be provided in other examples. Similarly, rather than a generic thread identifier, user interaction application 601 may display a more descriptive identifier for each of conversation threads 621-624, such as a topic/title for each thread. If the user were to select one of the identifiers for conversation threads 621-624, then user interaction application 601 may display the posts within the conversation thread and provide the user with the ability to craft their own post for submission to the thread.

Trend indicators 611-614 are displayed nearby respective ones of conversation threads 621-624 to provide trend information, as determined by a post overlook system, such as post overlook system 101. Trend indicators 611-614 represent the trend information as a bar-shaped timeline representing the lifetime of the thread with the left side of the bar representing creation time of the thread and the right side representing the current time (other example timelines may only represent a defined time period for the threads, such as the last 6 hours). Other types/styles of indicators may be used in other examples, which may depend on the trend information being displayed. While trend indicators 611-614 use various textures/patterns to show differences in trend information, other examples may use colors or some other type of visual differentiator. Trend indicator 611 is associated with a relatively new conversation thread 621 that has had three reply posts. Based on posting characteristics determined for conversation thread 621, trend indicator 611 indicates a pattern for the entirety of its timeline that conversation thread 621 is currently moderately active, and has been for substantially all of its lifetime (due to the pattern showing through the whole bar), but does not (at least not yet) reach the level of being important enough to be designated a trending thread. For example, the topic of conversation thread 621 may not be deemed important enough for conversation thread 621 to be trending even though it already has three replies, which may be from users of the group that represent a very low percentage of the overall strength of group members (e.g., are low level employees in the group or otherwise are of low influence, or the thread discussion is for a topic that spans very few members of the overall group strength).

Trend indicator 612 is associated with conversation thread 622 and shows a crossed-line pattern that indicates that conversation thread 622 is a trending thread. In this case, even if posting characteristics of posts in conversation thread 622 only recently caused a post overlook system to determine that conversation thread 622 is trending, the pattern fills the whole bar to better grab the attention of the user. When conversation thread 622 is determined to no longer be trending (e.g., the issue of conversation thread 622 may be resolved and posting activity may go down accordingly), trend indicator 612 may change to only show the trending pattern in a portion of trend indicator 612 that corresponds to when conversation thread 622 was trending. In contrast, trend indicator 613 is shown all black because over the life of conversation thread 623, conversation thread 623 has had low activity and is of low importance to the group since its creation. Trend indicator 614 indicates that conversation thread 624 had moderate activity early on after creation since the moderate activity pattern, also shown in trend indicator 611, is shown on the left side of conversation thread 624. Trend indicator 614 then turns black up till the current time, which shows that, for all but the first quarter of conversation thread 624's current lifetime, conversation thread 624 had low activity. As conversation thread 624 gets older and the lifetime extends, the portion of trend indicator 614 showing moderate activity will get smaller until it represents such a small percentage of conversation thread 624's lifetime that trend indicator 614 looks all black like trend indicator 613. In some examples, if conversation thread 624 was to increase in activity level after the time shown in implementation 600, then a pattern representing that activity level may start to fill trend indicator 614 from the right (or may take up the entirety of trend indicator 614 if conversation thread 624 becomes important and is trending to the group).

In some examples, each of trend indicators 611-614 may include user selectable segments that, when selected, open the associated conversation thread of conversation threads 621-624 to the posts that correspond to the time represented by the segment. For instance, each trend indicator may be separated into segments corresponding to a period of the timeline (e.g., may be separated into 15-minute increments). When the user selects (e.g., clicks on) one of those segments, the conversation thread opens up directly to the posts in the selected time period rather than, for example, opening to the most recent posts. In a particular example from implementation 600, trend indicator 614 may represent the past hour of time and may be divided into four segments representing 15 minutes each. Three of the segments are black to represent low activity while one segment shows moderate activity. If a user selects the segment having moderate activity, then conversation thread 624 will be opened directly to posts that were posted in the 15-minute period of moderate activity. In another example, a particular time interval is highly trending in a conversation thread, as indicated by the trend indicator. So, a user can directly select that particular segment of trend indicator that would take him to the posts exchanged within the highly trending time interval. Also, as indicated above, the user could be presented about a trending thread through some other forms e.g. through displaying text “The thread is trending or was trending in past”. In such presentation form, the user could be given an icon or even a component of the text itself could be clickable or selectable, after selection of which will take the user to the time interval when thread was trending.

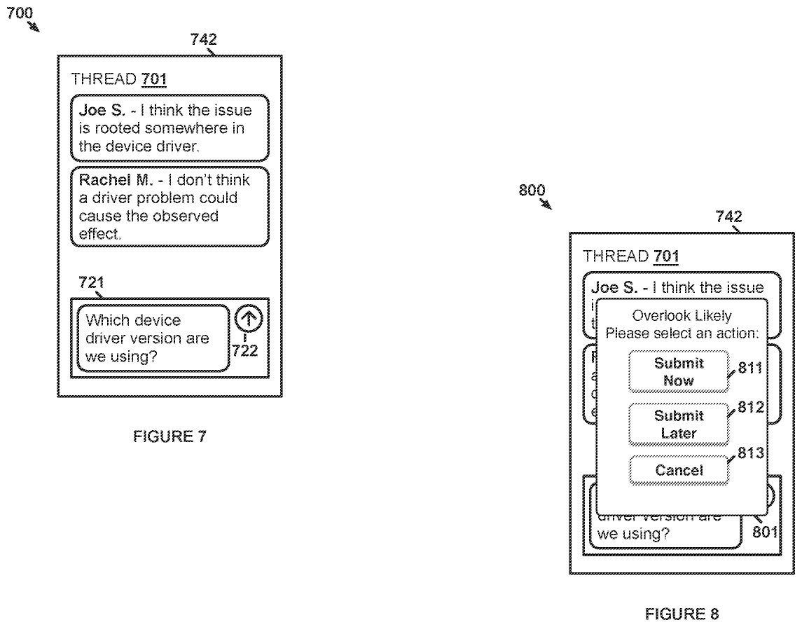

FIG. 7 illustrates implementation 700 for presenting identifiers for trending group conversation threads. Implementation 700 includes display screen 742. Display screen 742 may be a display screen similar to display screen 642, although display screen 742 is shaped differently. For example, display screen 742 may be a smartphone display while display screen 642 may be a laptop display. It should be understood that display screen 642 and display screen 742 may each be capable of displaying similar information, although, that information may be displayed differently to conform to physical differences between display sizes (e.g., display screen 742 may also display the conversation thread identifiers and trend indicators displayed by display screen 642).

In this example, display screen 742 is displaying posts from conversation thread 701, which may be presenting within a client application executing on a user device of display screen 742 (e.g., may be an app running thereon). A user of display screen 742 may have selected conversation thread 701 from a list of conversation threads like that shown in implementation 600. In this example, two posts are currently displayed, although, the user may be able to scroll through additional posts of conversation thread 701 that are not currently able to fit on display screen 742. The user has input a post of their own into post entry box 721. Post entry box 721 only accepts text input for posts in this example but, in other examples, post entry box 721 may allow posting of other types of content. When the user is ready to submit the post in post entry box 721 to conversation thread 701, the user presses submission button 722.

FIG. 8 illustrates implementation 800 for presenting identifiers for trending group conversation threads. Implementation 800 represents what may happen to implementation 700 after the user selects submission button 722. In particular, after submission button 722 is selected, display screen 742 displays overlook alert 801 as a popup window over the posts of conversation thread 701. Overlook alert 801 is displayed after a post overlook system determined that the probability of the user's post being overlooked satisfies overlook criteria, as was described in operational scenario 400. Overlook alert 801 provides the user with three options for proceeding. If submit now button 811 is selected, then the user system of display screen 742 will proceed with submitting the post at present (i.e., substantially immediately). If submit later button 812 is selected, then the user system will wait to submit the post until instructed to do so by the post overlook system, as was described in operational scenario 500. If cancel button 813 is selected, the post will not be submitted and display screen 742 may return to the state shown in implementation 700. The user can then decide to manually submit the post later, edit the post for later, delete the post from post entry box 721, or take some other action.

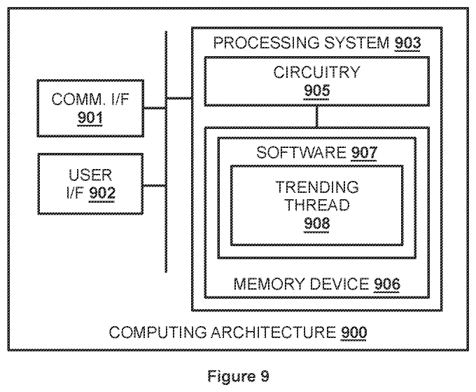

FIG. 9 illustrates a computing architecture 900 for presenting identifiers for trending group conversation threads. Computing architecture 900 is an example computing architecture for post overlook system 101, 301, and 401, although systems 101, 301, and 401 may use alternative configurations. A similar architecture may also be used for other systems described herein (e.g., conversation platform systems 102, 302, and 402 and user systems 103, 303, and 403), although alternative configurations may also be used. Computing architecture 900 comprises communication interface 901, user interface 902, and processing system 903. Processing system 903 is linked to communication interface 901 and user interface 902. Processing system 903 includes processing circuitry 905 and memory device 906 that stores operating software 907.

Communication interface 901 comprises components that communicate over communication links, such as network cards, ports, RF transceivers, processing circuitry and software, or some other communication devices. Communication interface 901 may be configured to communicate over metallic, wireless, or optical links. Communication interface 901 may be configured to use TDM, IP, Ethernet, optical networking, wireless protocols, communication signaling, or some other communication format—including combinations thereof.

User interface 902 comprises components that interact with a user. User interface 902 may include a keyboard, display screen, mouse, touch pad, or some other user input/output apparatus. User interface 902 may be omitted in some examples.

Processing circuitry 905 comprises microprocessor and other circuitry that retrieves and executes operating software 907 from memory device 906. Memory device 906 comprises a computer readable storage medium, such as a disk drive, flash drive, data storage circuitry, or some other memory apparatus. In no examples would a storage medium of memory device 906 be considered a propagated signal. Operating software 907 comprises computer programs, firmware, or some other form of machine-readable processing instructions. Operating software 907 includes trending thread module 908. Operating software 907 may further include an operating system, utilities, drivers, network interfaces, applications, or some other type of software. When executed by processing circuitry 905, operating software 907 directs processing system 903 to operate computing architecture 900 as described herein.

In particular, trending thread module 908 directs processing system 903 to determine posting characteristics for posts in a conversation thread between users in a group of users. The posting characteristics include a current topic for the conversation thread. Trending thread module 908 also directs processing system 903 to, based on the posting characteristics, determine an importance of the conversation thread to the group. In response to the importance satisfying trending criteria, trending thread module 908 directs processing system 903 to present an indication that the trending criteria is satisfied in association with an identifier of the conversation thread. The identifier is presented with identifiers for one or more other conversation threads associated with the group.

The descriptions and figures included herein depict specific implementations of the claimed invention(s). For the purpose of teaching inventive principles, some conventional aspects have been simplified or omitted. In addition, some variations from these implementations may be appreciated that fall within the scope of the invention. It may also be appreciated that the features described above can be combined in various ways to form multiple implementations. As a result, the invention is not limited to the specific implementations described above, but only by the claims and their equivalents.

1. A method comprising:
in a post overlook system:
accessing posts in a conversation thread between users in a group of users, wherein the conversation thread is hosted by a conversation platform system that receives the posts from user systems of the users;
determining posting characteristics for the posts, wherein the posting characteristics include a current topic for the conversation thread;
based on the posting characteristics, determining an importance of the conversation thread to the group; and
in response to the importance satisfying trending criteria, displaying, via a user system of the user systems, an indication that the trending criteria is satisfied in association with an identifier of the conversation thread, wherein the identifier is displayed with identifiers for one or more other conversation threads associated with the group.

2. The method of claim 1, comprising:
presenting a time-based indication of the importance changing over time in association with the identifier.

3. The method of claim 2, wherein the time-based indication comprises a timeline representing an amount of time up until a current time.

4. The method of claim 1, wherein the indication includes a user selectable identifier of a previous time when the trending criteria was satisfied, the method comprising:
upon receiving a selection of the user selectable identifier, opening the conversation thread to one or more of the posts that were posted during the previous time.

5. The method of claim 1, comprising:
determining post characteristics of a post for submission to the conversation thread;
determining a probability that the post will be overlooked by other users in the group based on the post characteristics; and
in response to a user instruction to submit a post to the conversation thread and the probability satisfying overlook criteria, presenting a visual alert informing the user that the post is likely to be overlooked, wherein the visual alert provides the user with a first option to presently proceed with submitting the post to the conversation thread and a second option to not proceed with submitting the post.

6. The method of claim 5, wherein the visual alert provides the user with a third option to delay submission of the post, and the method comprising, after selection of the third option:
determining second posting characteristics for the posts;
based on the second posting characteristics, determining a second probability that the post will be overlooked by the other users in the group; and
in response to determining that the second probability satisfies submission criteria, submitting the post to the conversation thread.

7. The method of claim 6, comprising:
after submitting the post, notifying the user that the post was submitted.

8. The method of claim 1, wherein the posting characteristics include one or more characteristics in a characteristics group comprising:
one or more topics other than the current topic;
a volume of the posts;
a flow rate of the posts;
a post time of a most recent one of the posts;
a user sentiment within the posts; and
one or more identities of the users.

9. The method of claim 8, wherein determining the importance comprises:
in response to determining that the user sentiment indicates urgency with respect to the current topic, adjusting the importance to indicate that the post is more important than had the urgency not been determined.

10. The method of claim 1, comprising:
training a machine learning algorithm using predefined indications of importance for previous posts, having previous posting characteristics, in a plurality of previous conversation threads, wherein the machine learning algorithm learns patterns in the previous posting characteristics associated with the predefined indications of importance;
wherein determining the importance comprises inputting the posting characteristics into the machine learning algorithm, wherein the machine learning algorithm outputs the importance.

11. An apparatus comprising:
one or more computer readable storage media;
a processing system operatively coupled with the one or more computer readable storage media; and
program instructions stored on the one or more computer readable storage media that, when read and executed by the processing system, direct the processing system to:
access posts in a conversation thread between users in a group of users, wherein the conversation thread is hosted by a conversation platform system that receives the posts from user systems of the users;
determine posting characteristics for the posts, wherein the posting characteristics include a current topic for the conversation thread;
based on the posting characteristics, determine an importance of the conversation thread to the group; and
in response to the importance satisfying trending criteria, display, via a user system of the user systems, an indication that the trending criteria is satisfied in association with an identifier of the conversation thread, wherein the identifier is presented with identifiers for one or more other conversation threads associated with the group.

12. The apparatus of claim 11, wherein the program instructions direct the processing system to:
present a time-based indication of the importance changing over time in association with the identifier.

13. The apparatus of claim 12, wherein the time-based indication comprises a timeline representing an amount of time up until a current time.

14. The apparatus of claim 11, wherein the indication includes a user selectable identifier of a previous time when the trending criteria was satisfied, and wherein the program instructions direct the processing system to:
upon receipt of a selection of the user selectable identifier, opening the conversation thread to one or more of the posts that were posted during the previous time.

15. The apparatus of claim 11, wherein the program instructions direct the processing system to:
determine post characteristics of a post for submission to the conversation thread;
determine a probability that the post will be overlooked by other users in the group based on the post characteristics; and
in response to a user instruction to submit a post to the conversation thread and the probability satisfying overlook criteria, present a visual alert informing the user that the post is likely to be overlooked, wherein the visual alert provides the user with a first option to presently proceed with submitting the post to the conversation thread and a second option to not proceed with submitting the post.

16. The apparatus of claim 15, wherein the visual alert provides the user with a third option to delay submission of the post, and wherein the program instructions direct the processing system to, after selection of the third option:
determining second posting characteristics for the posts;
based on the second posting characteristics, determining a second probability that the post will be overlooked by the other users in the group; and
in response to determining that the second probability satisfies submission criteria, submitting the post to the conversation thread.

17. The apparatus of claim 16, wherein the program instructions direct the processing system to:
after the post is submitted, notify the user that the post was submitted.

18. The apparatus of claim 11, wherein the posting characteristics include one or more characteristics in a characteristics group comprising:
one or more topics other than the current topic;
a volume of the posts;
a flow rate of the posts;
a post time of a most recent one of the posts;
a user sentiment within the posts; and
one or more identities of the users.

19. The apparatus of claim 18, wherein to determine the importance, the program instructions direct the processing system to:
in response to determining that the user sentiment indicates urgency with respect to the current topic, adjust the importance to indicate that the post is more important than had the urgency not been determined.

20. One or more computer readable storage media having program instructions stored thereon that, when read and executed by a processing system, direct the processing system to:
access posts in a conversation thread between users in a group of users, wherein the conversation thread is hosted by a conversation platform system that receives the posts from user systems of the users;
determine posting characteristics for the posts, wherein the posting characteristics include a current topic for the conversation thread;
based on the posting characteristics, determine an importance of the conversation thread to the group; and
in response to the importance satisfying trending criteria, display, via a user system of the user systems, an indication that the trending criteria is satisfied in association with an identifier of the conversation thread, wherein the identifier is presented with identifiers for one or more other conversation threads associated with the group.
